(19) United States
(12) Patent Application Publication
(10) Pub. No.: US 2011/0241977 A1
(43) Pub. Date: Oct. 6, 2011

(54) ENHANCED VIEWING BRIGHTNESS FOR SURFACE DISPLAY

(75) Inventor: Karlton Powell, Lake Stevens, WA (US)

(73) Assignee: MICROSOFT CORPORATION, Redmond, WA (US)

(21) Appl. No.: 12/752,741

(22) Filed: Apr. 1, 2010

(51) Int. Cl. G09G 3/00; F21V 8/00; G03B 21/20; G09F 13/04

(52) U.S. Cl. 345/32; 362/330; 353/102; 362/97.1

(57) ABSTRACT

A display panel includes an array of refractive elements arranged on a substrate. The array is positioned to receive light of a first intensity profile and configured to transmit in a second intensity profile at least some of the light received. The display panel also includes a diffuser positioned to receive the light transmitted by the array of refractive elements and configured to transmit in a third intensity profile at least some of the light received. The second intensity profile has a lower relative intensity normal to the substrate than has the first intensity profile.

### BACKGROUND

A display panel may be viewed from various angles depending on its orientation relative to one or more viewers. In many applications in which a display panel is viewed, such orientation falls within a predictable range. For television viewing and computer monitoring, for example, viewers may be seated directly in front of the display panel, or at least eye-level to the display panel. Accordingly, a display panel used in these applications may be configured to emit maximum light intensity normal to the display panel surface, the intensity falling off isotropically or anisotropically with increasing viewing angle. However, such a configuration may distribute the available light energy inefficiently in applications where the viewers are not eye-level to the display panel or seated directly in front of the display panel.

### SUMMARY

Therefore, one embodiment provides a display panel that includes an array of refractive elements arranged on a substrate. The array is positioned to receive light of a first intensity profile and configured to transmit in a second intensity profile at least some of the light received. In this embodiment, the second intensity profile has a lower relative intensity normal to the substrate, and a higher relative intensity oblique to the substrate, than has the first intensity profile.

It will be understood that the summary above is provided to introduce in simplified form a selection of concepts that are further described in the detailed description, which follows. It is not meant to identify key or essential features of the claimed subject matter, the scope of which is defined by the claims that follow the detailed description. Further, the claimed subject matter is not limited to implementations that solve any disadvantages noted herein.

### BRIEF DESCRIPTION OF THE DRAWINGS

FIG. 1 schematically shows a reference arrangement involving a viewer and a vertically oriented display panel.

FIG. 2 schematically shows an example arrangement involving a viewer and a horizontally oriented, large-format display panel in accordance with an embodiment of this disclosure.

FIG. 3 shows a graph of a desired intensity profile for light emitted by a display panel in accordance with an embodiment of this disclosure.

FIG. 4 schematically shows aspects of an example optical system for a display panel in accordance with an embodiment of this disclosure.

FIG. 5 schematically shows a vertical cross section of angle-expanding layer of an optical system in accordance with an embodiment of this disclosure.

FIG. 6 shows an example microstructured refractor of an optical system in accordance with an embodiment of this disclosure.

FIGS. 7 and 8 show vertical cross sections of other example angle-expanding layers of optical systems in accordance with embodiments of this disclosure.

FIG. 9 schematically shows aspects of another example optical system for a display panel in accordance with an embodiment of this disclosure.

### DETAILED DESCRIPTION

The subject matter of this disclosure is now described by way of example and with reference to certain illustrated embodiments. Components that may be substantially similar in one or more embodiments are identified coordinately. It will be noted, however, that components identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

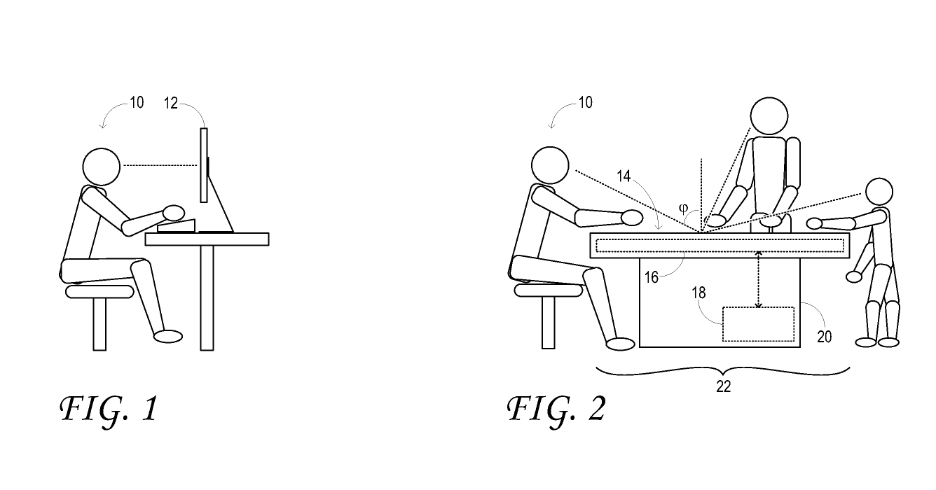

FIG. 1 schematically shows a reference arrangement involving a viewer 10 and a vertically oriented display panel 12. In FIG. 1, the viewer is seated directly in front of the display panel. Accordingly, the intensity profile of the light emitted by the display panel may be optimized for vertical orientation. The term ‘intensity profile’ is used herein to denote the power or flux of the light as a function of viewing angle. In particular, the display panel may be configured to emit maximum light intensity normal to its front surface—i.e., at 0 degrees relative to the surface normal. This configuration makes efficient use of the available light energy by directing the emission to a range of angles where it will likely be viewed. In such configurations, the light intensity may fall off with increasing viewing angle according to a Gaussian or Lambertian profile or to an anisotropic product of Lambertian profiles. For example, the light intensity may fall off sharply with increasing viewing angle in the vertical direction and more gradually with increasing viewing angle in the horizontal direction. This is because the viewer may regularly view a vertically oriented display panel from the left or right sides, but is unlikely to view it from above or below.

In principle, display panel 12 can be used in applications where it is not oriented vertically, even if its illumination profile is optimized for vertical orientation. However, some alternative orientations of the display panel relative to the viewer may result in a lower light intensity for the range of angles over which the display panel is viewed, making inefficient use of the available light energy. Such an orientation is illustrated by example in FIG. 2.

FIG. 2 schematically shows another arrangement involving a viewer and a display panel. In FIG. 2, viewer 10 is seated beside a large-format, horizontally oriented display panel 14. The display panel is of such size that the viewer would typically view it from an oblique viewing angle φ relative to the surface normal. In one example, for an adult viewer of average stature seated at a comfortable height and distance from the display panel, the most probable viewing angle may be 51 degrees. Naturally, the viewing angle will vary with the stature and disposition of the viewer—being less than 51 degrees for taller viewers and viewers standing beside the display panel, and greater than 51 degrees for viewers of small stature. In one example, when a range of viewers and viewer dispositions is considered, suitable viewing angles may fall in the range of 20 to 70 degrees. Therefore, as further described hereinafter, display panel 14 may be configured to emit maximum light intensity at such oblique angles or ranges of angles. In this manner, the display panel may be optimized to make efficient use of the available light energy when oriented horizontally. It will be understood that the numerical values and ranges recited herein are examples only, and that other values and ranges are fully consistent with this disclosure.

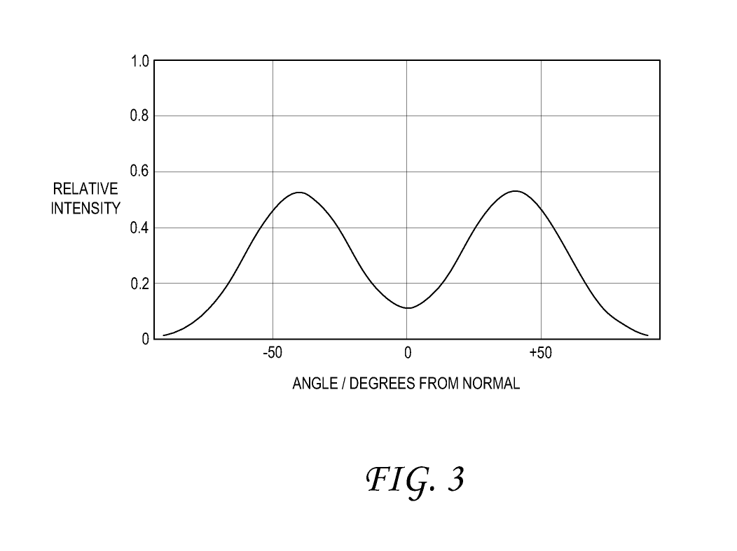

The graph of FIG. 3 illustrates an example intensity profile that may be desired for the light emitted by display panel 14. The illustrated intensity profile is annular and diffuse, having a local minimum 0 degrees from normal and local maxima at ±θ from the normal, ±40 degrees in this example. Further, the local maxima within the intensity profile are approximately Gaussian, having a full width at half maximum (FWHM) of 45 degrees. In addition, it will be noted from FIG. 3 that the light intensity approaches extinction at 90 degrees from the normal. This feature is advisable for avoidance of backscatter and total internal reflection (TIR) in the components of the display panel, which could otherwise give rise to illumination artifacts such as ‘blooming’ or ‘halo’. Naturally, desired intensity profiles of various other shapes are also fully consistent with this disclosure. For example, another desired intensity profile may have no local minimum but be substantially flat in an interval around 0 degrees. Such an intensity profile may allow a feasible performance tradeoff between a horizontal and a vertical form factor, such that the same display panel might be somewhat efficiently usable in both scenarios.

Relative to intensity profiles of display panels optimized for vertical orientation, the intensity profile shown in FIG. 3 provides increased relative intensity at larger viewing angles. Such larger viewing angles are within the range expected for display panel 14 oriented as shown in FIG. 2. At viewing angles of 50 and 70 degrees, respectively, the relative intensity may be 1.3 and 1.5 times that of a display panel optimized for vertical orientation. Moreover, the intensity profile shown in FIG. 3 provides reduced relative intensity at very acute viewing angles from which display panel 14 is unlikely to be viewed. At a viewing angle of 0 degrees, for example, the relative intensity may be 0.1 times that of a display panel optimized for vertical orientation.

Returning now to FIG. 2, display panel 14 includes optical system 16. The optical system comprises an assembly of electronic and optical components configured to form a display image on the display panel. Further, the optical system may form the display image using light having an intensity profile as described above. FIG. 2 also shows computer system 18 operatively coupled to optical system 16. The computer system may be configured to provide data to the display panel for forming the display image.

In some embodiments, optical system 16 may also include an imaging stack configured to sense objects placed on or near display panel 14. Accordingly, the computer system may be configured to receive input data from the imaging stack. In this manner, the optical system may provide at least some input functionality for computer system 18. In the embodiment shown in FIG. 2, the computer system is contained within pedestal 20, which is located below display panel 14; taken together, the pedestal and the display panel comprise console 22. In other embodiments, all or part of the computer system may be located remotely and operatively coupled to the optical system via a wired or wireless communications link In still other embodiments, the computer system and the optical system may both be located within the display panel.

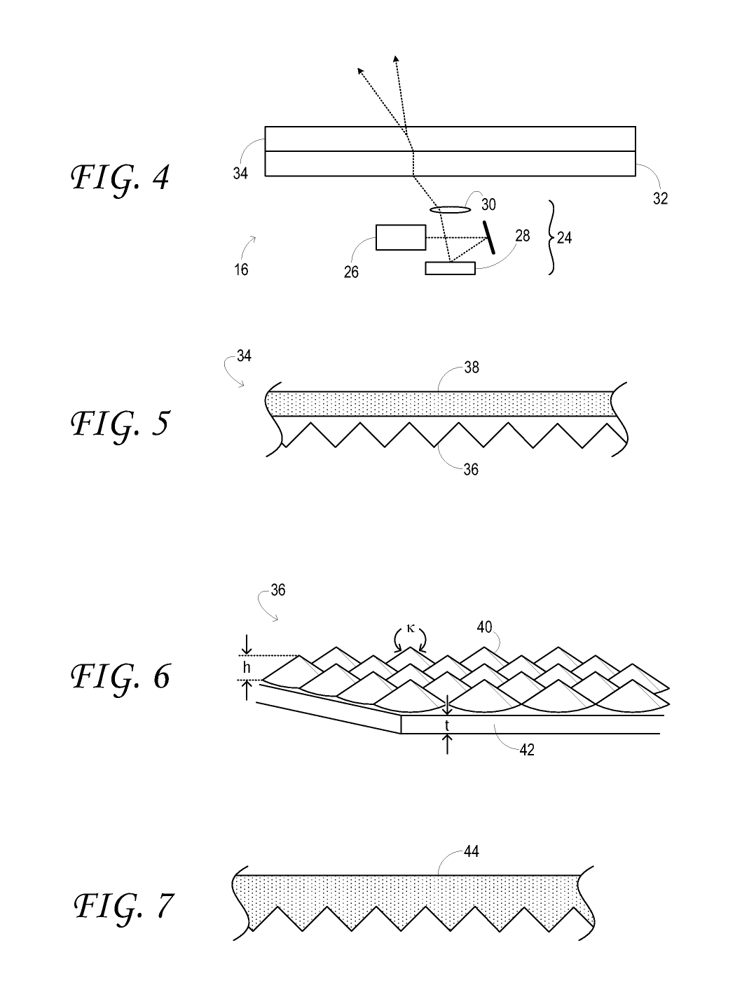

FIG. 4 schematically shows aspects of optical system 16 in one embodiment. The optical system includes image projector 24 in which light source 26 is arranged. In one embodiment, the light source may comprise a wavelength-selective element such as a rotating prism or color wheel in combination with any suitable source of white light—an arc lamp, incandescent lamp, or cold-cathode fluorescent lamp (CCFL), for example. In other embodiments, the light source may comprise a plurality of narrow-band light sources—lasers or light-emitting diodes (LED's), for example.

Image projector 24 also includes image-forming matrix 28 arranged to receive light from the light source. The image-forming matrix may be any suitable component configured to spatially and temporally modulate the light to form a display image. In the embodiment shown in FIG. 4, the image-forming matrix is a digital light processing (DLP) matrix that divides wavelength-selected light from the light source into a plurality of pixels, selectively directs some light from the pixels to imaging optic 30, and selectively directs other light from the pixels away from the imaging optic. Other embodiments may include a plurality of image-forming matrices configured to receive and direct light from a plurality of narrow-band light sources. In still other embodiments, the image-forming matrix may comprise an array of light valves mated to color filters. In such embodiments, the image-forming matrix may be configured to selectively transmit some light from the pixels and to selectively absorb other light from the pixels, thereby forming the display image.

Continuing in FIG. 4, optical system 16 includes collimating layer 32. The collimating layer may be any suitable optical layer arranged to receive light from image projector 24 and to collimate the light it receives. In one embodiment, the collimating layer may comprise a Fresnel lens or Fresnel-lens array supported on a polymer film. In the embodiment shown in FIG. 4, the collimating layer is positioned between the image projector 24 and angle-expanding layer 34, such that the light received into the collimating layer is directed, in collimated form, into the angle-expanding layer. The angle-expanding layer may be positioned to receive the collimated light from the collimating layer; it may be configured to retransmit such light in a desired intensity profile (e.g., the intensity profile shown in FIG. 3).

FIG. 5 schematically shows a vertical cross section of angle-expanding layer 34 in one example embodiment. The angle-expanding layer includes microstructured refractor 36 and diffuser 38. The microstructured refractor is positioned to receive light of a first intensity profile (e.g., the collimated light from collimating layer 32), and configured to transmit at least some of the light received in a second intensity profile.

FIG. 6 shows one embodiment of microstructured refractor 36 in greater detail. In the illustrated embodiment, the microstructured refractor comprises an axicon array—viz., an array of hexagonally tiled conical lenslets 40. The pitch and therefore the density of the array may differ in the various embodiments of this disclosure, and may depend on whether an imaging stack (vide infra) is included in the optical system. In particular, the chosen pitch may be of sufficient small size to interfere minimally with the imaging stack, while not causing artifacts, such as aliasing, to appear in the display content. In one embodiment, the microstructured refractor may include 600 conical lenslets per square centimeter (cm²). This lenslet density may be appropriate to provide a pitch on the order of the display pixel size d, where d=0.43 mm; accordingly, a lenslet density of 320/cm² may be used where d=0.43 mm In embodiments where the pitch is set to one third of the display pixel size, the lenslet density may be as high as 5000/cm².

In one embodiment, each of the conical lenslets 40 embodies a right circular cone having a height h and an aperture κ (defined as the maximum angle between any two genatrix lines of the cone). In one particular embodiment, h may be 0.46 mm, and κ may be 66.5 degrees. More generally, appropriate metrics for the various elements of microstructured refractor may be determined based on the desired final light intensity profile, on the refractive indices of the materials forming the angle-expanding layer, and on the light-diffusing power of diffuser 38. In this manner, the microstructured refractor may very efficiently redistribute the light it receives.

Continuing in FIG. 6, the conical lenslets 40 of microstructured refractor 36 may be arranged on, supported by, and in some examples formed in substrate layer 42. The substrate layer may have any suitable thickness t. In certain embodiments, the entire microstructured refractor (refractive elements plus substrate layer) may comprise a preformed polymer film. In one particular embodiment, such a film may be laminated onto diffuser 38. As shown in FIG. 6, the apices of conical lenslets 40 are oriented away from the substrate. More generally, the apices of any refractive element of the microstructured refractor may be oriented away from the substrate.

The second intensity profile in which microstructured refractor 36 transmits the light it receives may have a lower relative intensity normal to substrate layer 42 than has the first intensity profile. Accordingly, it may have a higher relative intensity oblique to the substrate layer than has the first intensity profile. In one embodiment, the second intensity profile may be annular. Further, the microstructured refractor may direct the transmitted light through well-defined foci; this property may be exploited in some embodiments to enhance the display panel's ability to reject ambient light, as further described hereinafter.

Returning now to FIG. 5, diffuser 38 is an optical layer positioned to receive light transmitted by microstructured refractor 36 and configured to transmit in a third intensity profile at least some of the light received. In embodiments where the second intensity profile is annular, the third intensity profile may be diffuse and annular. In this manner, the light exiting the diffuser may acquire an intensity profile such as the one shown in FIG. 3, where an intensity oblique to display panel 14 is the strongest intensity. Further, the diffuser may confer desirable ambient-light rejection qualities on angle-expanding layer 34. Such qualities may effectively conceal the various internal structures of optical system 16 and may reduce specular reflection from ambient light sources. Diffuser 38 may be coupled to microstructured refractor 36 in any suitable manner; it may be film laminated to the microstructured refractor, bonded using an optical adhesive, ultraviolet (uv) cast, or formed via multi-sheet molding, for example.

In the embodiment shown in FIG. 5, diffuser 38 is a volume-type diffuser, in which a plurality of refractive and/or light-scattering elements are distributed within a three-dimensional volume. In one example, a volume-type diffuser may comprise a flexible film having a controlled density of light scattering elements, such as particles, distributed and fixed therein. Configured in this manner, the volume-type diffuser may expand the intensity profile of the light received according to a Henyey-Greenstein factor, and it may diffuse incident ambient light by the same Henyey-Greenstein factor. One such volume-type diffuser is product ADF4040 (40 degrees FWHM case) of Fusion Optix Corporation. In other embodiments, the volume-type diffuser may incorporate a controlled amount of a tinting agent (i.e., a dye or other visible-light absorbing substance) for enhanced ambient-light rejection. In still other embodiments, the volume-type diffuser may support a roughened or dimpled upper surface (viz., the surface facing the viewer) to further limit specular reflection and reject ambient light.

FIG. 7 schematically shows a vertical cross section of another angle-expanding layer 44 comprising an microstructured refractor and a volume-type diffuser. The angle-expanding layer shown in FIG. 7 is monolithic, inasmuch as the conical lenslets of the microstructured refractor (as described hereinabove) are molded directly onto a surface of the volume-type diffuser (viz., the surface facing away from the viewer). Thus, the diffuser may be the very substrate on which the conical lenslets or other refractive elements are arranged. Such elements may be formed in the angle-expanding layer by compression molding, for example. In one embodiment, the light-scattering elements of the angle-expanding layer may be distributed inhomogeneously—e.g., at least partly segregated away from the conical lenslets formed therein.

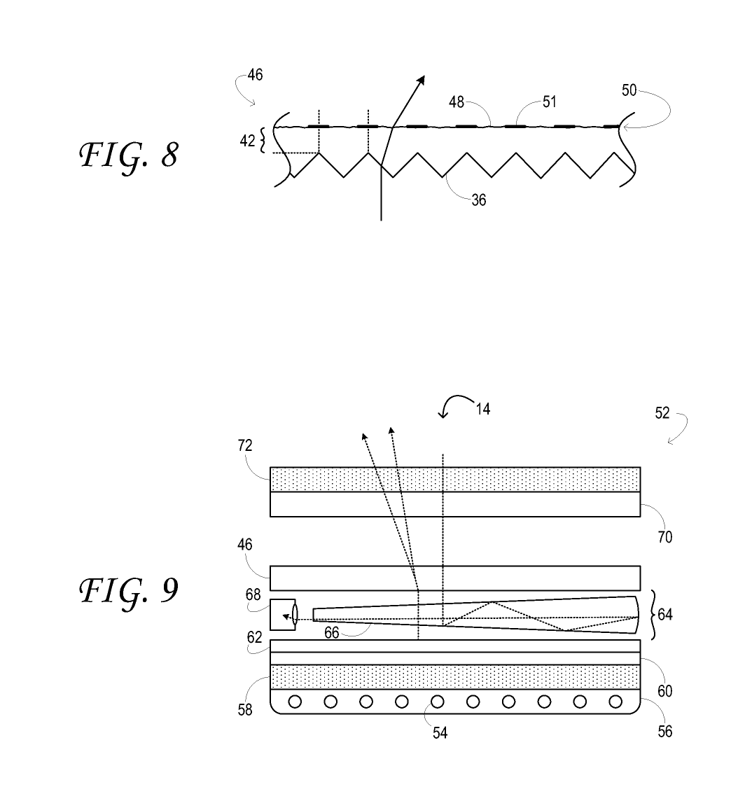

FIG. 8 schematically shows a vertical cross section of another angle-expanding layer 46 in one embodiment. Here, a plurality of refractive and/or light-scattering elements 48 are arranged on a surface of substrate layer 42, thereby forming a surface-relief type diffuser 50. Such light-diffusing surface features may in one embodiment comprise periodic or aperiodic arrays of concave or convex lenslets, dimples, or bumps. In one embodiment, the surface features may be molded directly onto substrate layer 42. Suitable molding techniques include thermal molding and uv-casting, as examples. In another embodiment, a film having such features may be laminated onto the substrate layer, rolled thereon (e.g., by heat-press rolling), or formed via screen-printing. Surface features that can be applied via rolling or screen printing include white dots, microdots, or diffusing pads. In one embodiment, such features may diffuse visible light but be substantially transparent in the infrared.

Configured in this manner, surface-relief type diffuser 50 may expand the intensity profile of the display image light according to a Gaussian factor and may diffuse ambient light by the same Gaussian factor. In the embodiment shown in FIG. 8, microstructured refractor 36 is arranged on substrate layer 42 opposite the diffuser. One such surface-relief type diffuser is product L45E5 Light Shaping Diffuser (providing 45 degrees FWHM angular spread) from Luminit, LLC of Torrance, Calif.

To further enhance ambient-light rejection by angle-expanding layer 46, an array of opaque elements 51 are arranged on substrate layer 42, along with light-diffusing features 48. In the embodiment shown in FIG. 8, the opaque elements are positioned in registry with the apices of microstructured refractor 36, such that the foci (or circle of confusion) of the conical lenslets of the microstructured refractor lie in or near the plane of diffuser 50 and between adjacent opaque elements. This approach allows low-loss transmission of the display light through the foci while reducing the reflection of ambient light between the foci, as by absorbing ambient light illuminating these regions. In principle, overall ambient light reflection can be reduced in this manner by a factor equal to the transparent-to-opaque area ratio of the diffuser—1:4 in some examples. Accordingly, ambient light rejection can be improved markedly without degrading the illumination intensity. This approach requires accurate positioning of the opaque elements relative to the apices of the microstructured refractor. Such accuracy may be achieved via a patterned masking process. A mask may be formed via any suitable molding process—a self-aligned aperture masking process, in one example.

In one embodiment, opaque elements 51 may be black. In another embodiment, the opaque elements may be opaque to visible light but at least partly transparent to infrared light. This variant is particularly suited to optical system embodiments that include an infrared-based imaging stack positioned above the angle-expanding layer, as described below.

In these and other embodiments, it is desirable to design angle-expanding layer 34 thick enough to be reasonably robust. In order to maintain balance yet increase robustness, the angle-expanding layer may be laminated to a thicker substrate which may serve as the touch surface, but the thickness of such a substrate should be constrained enough in order to limit the amount of parallax between the touch location and the display content location. One example would be an angle-expanding layer between 0.5 and 1 millimeter (mm) thick laminated to the bottom side of a chemically hardened glass substrate, such as Gorilla Glass (a product of Corning, Inc., Corning, N.Y.), between 2 and 5 mm thick. A Fresnel lens can be placed below this laminated sheet to provide collimated input to the angle-expanding layer. The Fresnel lens may be molded in a thick enough sheet to hold its own weight, while the laminated angle-expanding layer is supported by the top thick glass substrate, providing significant robustness when subjected to weight and drop impacts. The top surface may be coated with an anti-reflection coating in order to reduce ambient reflection. Further, a hard coat may be added, or, an anti-reflection and hard-coated additional film may be laminated, in order to provide further durability. In this scenario, ambient rejection masking may be used as well, such that the display panel stack includes: array of refractive elements, volume diffuser, masking, lamination bond, and glass substrate (which may be anti-reflective coated). In this case, the Fresnel lens would be placed below the display panel stack with an air gap, and would have its own support by either being thick or being laminated onto a substrate appropriately thick to support its weight and prevent sag, with Fresnel grooves facing up toward bottom of the display panel stack.

Additional embodiments are contemplated besides those described above. In some embodiments, for example, the angle-expanding layer may comprise no diffuser at all. Such a configuration could be appropriate when suitably diffuse (not fully collimated) light is received into the angle-expanding layer, or when one or more light-diffusing components are arranged optically downstream of the angle-expanding layer. In still other embodiments, the microstructured refractor may comprise other refractive elements instead of or in addition to an axicon array. These include an array of apically rounded or apically flattened pseudo-conical lenslets, an array of tapered microrods, or a controlled-dimpled array in which case the dimple size and position is varied such that light illuminating a region of such features provides for the angle expanding. In one alternate embodiment for the projection display screen case, the pitch of the array of refractors may be pseudo-randomized in order to reduce possibility of aliasing between the display pixel pitch and array pitch. Further, two or more layers of aligned prismatic elements in a one-dimensional array may be used in place of an axicon array. In one example, the angle-expanding layer may comprise a first prismatic array aligned in a first direction and a second prismatic array aligned in a second direction orthogonal to the first. In another example, the angle-expanding layer may comprise first, second, and third prismatic arrays aligned 60 degrees from each other.

FIG. 9 schematically shows another example optical system 52 in one embodiment. The optical system includes a plurality of lamps 54 arranged inside backlight envelope 56. The lamps may include incandescent lamps, CCFL's, or LED's, for example. The backlight envelope may include one or more openings on one side (e.g., the top side in the drawing), from which the light escapes. The backlight envelope may also include an at least partly reflective interior surface for allowing light that does not escape to be recycled. Diffuser 58 is shown coupled to the open side of the backlight envelope. The light-diffusing power of the diffuser may be sufficient to provide uniform illumination over the open side of the backlight envelope; the light exiting the diffuser may have a Gaussian intensity profile.

In the embodiment shown in FIG. 9, first angle-limiting layer 60 is coupled to diffuser 58, and second angle-limiting layer 62 is coupled to the first angle-limiting layer. The first and second angle-limiting layers may each be configured to transmit light incident within a range of angles and to reflect light incident outside of the range of angles. In one embodiment, the first and second angle limiting layers may each comprise a layer having a prismatic micro- or millistructure. The prismatic elements of the first angle-limiting array may be oriented in a first direction, while those of the second angle-limiting layer may be oriented in a second direction orthogonal to the first. Further, the ranges of incidence angles to which the transmitted light is limited may be the same or different for the first and second angle-limiting layers. In this manner, the first and second angle-limiting layers may be configured to transmit an isotropic or anisotropic intensity profile. In one embodiment, the first and/or second angle-limiting layers may comprise a light-recycling, brightness enhancing film (BEF); the BEF may limit the profile of transmitted light to a 40 to 50 degree exit cone, for example. In other embodiments, however the angle-limiting layers may be omitted, resulting in increased intensity at greater viewing angles.

In the embodiment shown in FIG. 9, optical system 52 further includes imaging stack 64. The imaging stack may comprise an assembly of electronic and optical components configured to image one or more objects disposed on or above display panel 14. Such objects may include a finger or a stylus; imaging the objects may enable a touch- or object-sensitive input mechanism for a computer system (computer system 18 of FIG. 1, for example). Arranged above the backlight in optical system 52, the imaging stack may be configured for high visible transparency, especially in a direction normal to the surface of the display panel. Accordingly, the imaging stack may employ a narrow-band infrared illumination source (not shown in the drawings), and may be configured to image infrared light reflected from objects on or near the display panel. In the particular embodiment shown in FIG. 9, wedge-shaped light guide 66 supports a dichroic turning film opposite the viewing surface of the display panel, and a mirrored end face. This structure focuses the reflected infrared light onto camera 68, where the objects are imaged. It will be understood, however, that other, quite different imaging stacks are equally contemplated, some employing an offset-imaging approach. In such embodiments, the imaging stack may reflect infrared light associated with an input image while transmitting visible light for forming the display image.

Continuing in FIG. 9, optical system 52 includes angle-expanding layer 46, arranged above imaging stack 62 and configured substantially as described above. The optical system further includes image-forming matrix 70 arranged to receive light from the angle-expanding layer and to form a display image by spatially and temporally modulating the light. In one embodiment, the image-forming matrix comprises a plurality of light valves—e.g., a liquid-crystal display (LCD) matrix. The optical system further includes diffuser 72 coupled to the image-forming layer and configured to transmit the display image while scattering ambient light and masking the structural components of the optical system.

Other embodiments are contemplated as well. In one embodiment, an angle-expanding layer or layers may be arranged directly over an angle-limiting layer or layers of the back light assembly. Here, the imaging stack could be used with a diffuser laminated in close proximity to the top or bottom side of the display panel, and further the diffuser could include a switchable diffuser, such as a polymer dispersed liquid crystal (PDLC). In this case, a light-guide based frontlight (not shown in the figures) may be included in order to provide infrared illumination above the display panel. Alternatively, the imaging stack may be omitted, or it may be integrated into the image-forming matrix using so-called ‘sensor-in-pixel’ (SIP) technology. In such case, the angle-expanding layer may be placed above the backlight unit, and a diffuser or diffuser layers may be placed just below the SIP panel. In another embodiment, the angle-expanding layer may be arranged directly over the back light assembly, and the first and second angle-limiting layers may be omitted. This configuration will further increase the light intensity provided at larger viewing angles relative to the display panel normal. In one further embodiment, where BEF films are used to contain the light output of the backlight within a desired 40 to 50 degree spread, the diffuser may not be needed absent the vision system, since the BEF output approximates the desired angular spread that would be provided by the diffuser. Such an embodiment could include an axicon array or two or three crossed, one-dimensional prismatic arrays to provide the desired light-intensity profile.

Further, when using an array of LEDs for both visible display light as well as infrared imaging illumination, an axicon array and/or stack of crossed prismatic arrays could be used to achieve high angle bias, and a diffuser some distance away could be used to conceal the cavity placed just below the SIP/LCD panel.

Finally, it will be understood that the articles, systems and methods described herein are exemplary in nature, and that these specific embodiments or examples are not to be considered in a limiting sense, because numerous variations are contemplated. Accordingly, this disclosure includes all novel and non-obvious combinations and sub-combinations of the various systems and methods disclosed herein, as well as any and all equivalents thereof.

1. A display panel comprising:
an array of refractive elements arranged on a substrate, positioned to receive light of a first intensity profile, and configured to transmit in a second intensity profile at least some of the light received, the second intensity profile having a lower relative intensity normal to the substrate and a higher relative intensity oblique to the substrate than the first intensity profile.

2. The display panel of claim 1, further comprising a diffuser positioned to receive the light transmitted by the array of refractive elements and configured to transmit in a third intensity profile at least some of the light received.

3. The display panel of claim 1, wherein an intensity oblique to the substrate is a strongest intensity of the third intensity profile.

4. The display panel of claim 1, wherein the array of refractive elements comprises a plurality of apices, and wherein the apices are oriented away from the substrate.

5. The display panel of claim 1, wherein the array of refractive elements comprises two or more prismatic arrays.

6. The display panel of claim 1, wherein the array of refractive elements comprises an array of conical lenslets.

7. The display panel of claim 6, wherein the array of conical lenslets is hexagonally tiled.

8. The display panel of claim 1, wherein the diffuser comprises a plurality of refractive and/or light-scattering elements distributed within a volume of the diffuser.

9. The display panel of claim 1, wherein the diffuser comprises a surface layer on which a plurality of refractive, and/or light-scattering elements are arranged.

10. The display panel of claim 1, wherein the diffuser further comprises one or more of a tinting agent and an array of opaque elements.

11. The display panel of claim 1, wherein the diffuser is the substrate on which the array of refractive elements is arranged.

12. The display panel of claim 1, wherein the substrate and the array of refractive elements comprise a film.

13. The display panel of claim 12, wherein the film is laminated to the diffuser.

14. The display panel of claim 1, further comprising an image projector and a collimating layer, wherein the collimating layer is positioned between the image projector and the array of refractive elements, and wherein light is received into the array of refractive elements from the collimating layer.

15. The display panel of claim 14, further comprising a light valve, wherein light transmitted from the array of refractive elements or from the diffuser is received into the light valve.

16. A horizontally oriented display panel of such size as to be viewed obliquely, the display panel comprising:
an hexagonally tiled axicon array arranged on a substrate, positioned to receive light of a first intensity profile, and configured to transmit in a second intensity profile at least some of the light received, the second intensity profile having a lower relative intensity normal to the substrate and a higher relative intensity oblique to the substrate than the first intensity profile,
wherein the hexagonally tiled axicon array comprises a plurality of apices, and wherein the apices are oriented away from the substrate.

17. The display panel of claim 16, further comprising a diffuser, wherein an array of opaque elements is arranged on a surface of the diffuser, in registry with the plurality of apices of the axicon array.

18. A console comprising:
a display panel, comprising:
an array of refractive elements arranged on a substrate, positioned to receive light of a first intensity profile, and configured to transmit in a second intensity profile at least some of the light received, the second intensity profile having a lower relative intensity normal to the substrate and a higher relative intensity oblique to the substrate than the first intensity profile; and
a diffuser positioned to receive the light transmitted by the array of refractive elements and configured to transmit in a third intensity profile at least some of the light received; and
a computer system operatively coupled to the display panel and configured to provide data to the display panel for forming a display image on the display panel.

19. The console of claim 18, wherein the display panel further comprises an imaging stack, wherein the light received into the array of refractive elements is transmitted through the imaging stack, and wherein the computer system is configured to receive input data from the imaging stack.

20. The console of claim 19, wherein the diffuser comprises one or more of a tinting agent and an array of opaque elements, wherein the imaging stack projects and receives infrared light, and wherein the one or more of the tinting agent and the array of opaque elements is more transmissive to the infrared light than to visible light.
